(19) United States
(12) Patent Application Publication
(10) Pub. No.: US 2010/0305788 A1
(43) Pub. Date: Dec. 2, 2010

(54) METHOD FOR ADAPTING AT LEAST ONE PARAMETER IN A CONTROLLED SYSTEM OF A VEHICLE

(75) Inventor: Manfred Walter, Neufahrn (DE)

Correspondence Address: BARNES & THORNBURG LLP, 750-17TH STREET NW, SUITE 900, WASHINGTON, DC, 20006-4675, US

(73) Assignee: KNORR-BREMSE SYSTEME FUR SCHIENENFAHRZEUGE GMBH, Munchen (DE)

(21) Appl. No.: 12/675,803

(22) PCT Filed: Sep. 17, 2008
(86) PCT No.: PCT/EP2008/007763

§ 371 Date: Mar. 1, 2010

(30) Foreign Application Priority Data
Sep. 19, 2007 (DE) 10 2007 044 575.1

(51) Int. Cl. B60T 7/12; G01C 21/00; G01S 19/42; G06F 19/00

(52) U.S. Cl. 701/20; 701/207; 701/213; 701/19

(57) ABSTRACT

The invention relates to a method for adapting at least one parameter in a controlled system of a vehicle, wherein at least some of the possible positions of the vehicle within a road network that can be traveled by the vehicle are associated with at least one position-related boundary condition of the road network. The at least one parameter in the controlled system of the vehicle is adapted during travel as a function of the current position of the vehicle based on the position-related boundary conditions that are present there.

### PRIOR ART

The invention is based on a method for adapting at least one parameter in an open-loop-controlled or closed-loop-controlled system of a vehicle, as claimed in claim 1.

Modern vehicles often have open-loop-controlled or closed-loop-controlled systems which trigger specific reactions either through activation by the driver or else automatically. In rail vehicles, such a system is, for example, a device for detecting derailing, wherein a threshold value for the triggering of a detection signal for derailing has to be determined. Furthermore, in rail vehicles there is usually also an emergency brake device present for rapid application of the brake as well as a speed control device for performing closed-loop control of the speed. The parameters within such open-loop-controlled or closed-loop-controlled systems such as, for example, setpoint values or threshold values with which actual values are compared are usually permanently predefined variables which are no longer changed after the system has been programmed, even if the peripheral conditions to which the vehicle is subjected during operation change as a function of the route.

In contrast with the above, the invention is based on the object of making available a method with which open-loop-controlled or closed-loop-controlled systems of vehicles become more flexible.

According to the invention, this object is achieved by means of the features of patent claim 1.

### DISCLOSURE OF THE INVENTION

The invention proposes a method for adapting at least one parameter in an open-loop-controlled or closed-loop-controlled system of a vehicle, wherein at least one position-related peripheral condition of a route network is assigned to at least some of the possible positions of the vehicle within the route network which can be travelled along by the vehicle, and the at least one parameter is adapted in the open-loop-controlled or closed-loop-controlled system of the vehicle during the journey as a function of the current position of the vehicle on the basis of the position-related peripheral condition present there.

The method consequently provides the possibility of adapting parameters in an open-loop-controlled or closed-loop-controlled system of a vehicle to the peripheral conditions which are present at the present position of the vehicle within the route network, as a function of said present position of the vehicle. Depending on the parameters, this can lead, for example, to an increase in the operational safety or to a reduction in the consumption of energy by the vehicle.

As a result of the measures specified in the subclaims, advantageous developments and improvements of the invention specified in the independent claim are possible.

The current position of the vehicle in the route network is particularly preferably determined by a global positioning system (GPS). Such systems have become readily commercially available and constitute comparatively cost-efficient and precise means for determining the position of vehicles.

According to one particularly preferred application, the method for adapting at least one parameter is provided in an open-loop-controlled or closed-loop-controlled system of a rail vehicle which is operated within a rail network.

In this case the at least one position-related peripheral condition is an information item from the following group of information items: the positive gradient or the negative gradient, the quality, the maintenance state of the rail network at a specific position or the presence of a tunnel or of a bridge at a specific position on the rail network.

If, for example, the open-loop-controlled or closed-loop-controlled system contains a device for detecting derailing of the rail vehicle, a threshold value for the triggering of a detection signal for derailing is adapted as a function of the current position of the rail vehicle. For example, the threshold value for the triggering of the detection signal is adapted as a function of the route characteristic and is given a higher setting on secondary rail lines of the rail network which are poorly maintained than on main rail lines which are well maintained.

If, on the other hand, the open-loop-controlled or closed-loop-controlled system contains an emergency braking device of the rail vehicle, for example triggering of the emergency brake is suppressed in a rail vehicle which is located in a tunnel or on a bridge because this could bring about an operationally undesired situation.

Furthermore, the open-loop-controlled or closed-loop-controlled system could contain an open-loop brake control system or a closed-loop brake control system of the rail vehicle, which control system is adapted as a function of the at least one position-related peripheral condition in such a way that, for example, when the vehicle travels along a negative gradient greater braking forces are generated than when the vehicle travels on level ground or on a positive gradient.

Last but not least, the open-loop-controlled or closed-loop-controlled system could contain a speed control device of the rail vehicle, and the speed of the rail vehicle could be subjected to closed-loop control as a function of the at least one position-related peripheral condition, in particular to such an effect that the maximum speed on sections of the rail which are poorly maintained is reduced compared to an otherwise applicable maximum speed.

1. A method for adapting at least one parameter in an open-loop-controlled or closed-loop-controlled system of a vehicle, the method comprising:
assigning at least one position-related peripheral condition of a route network to at least some of the possible positions of the vehicle within the route network which can be travelled along by the vehicle, and
adapting the at least one parameter, in the open-loop-controlled or closed-loop-controlled system of the vehicle, during the journey as a function of a current position of the vehicle based on the position-related peripheral condition present there.

2. The method of claim 1, wherein the current position of the vehicle in the route network is determined by a Global Positioning System (GPS).

3. The method of claim 1, wherein the method is provided for adapting at least one parameter in an open-loop-controlled or closed-loop-controlled system of a rail vehicle which is operated within a rail network.

4. The method of claim 3, wherein the at least one position-related peripheral condition is an information item from the following group of information items: the positive gradient or the negative gradient, the quality, the maintenance state of the rail network at a specific position, the presence of a tunnel or of a bridge at a specific position on the rail network.

5. The method of claim 3, wherein the open-loop-controlled or closed-loop-controlled system contains a device for detecting derailing of the rail vehicle, wherein a threshold value for the triggering of a detection signal for derailing is adapted as a function of the current position of the rail vehicle.

6. The method of claim 3, wherein the open-loop-controlled or closed-loop-controlled system contains an emergency brake device of the rail vehicle, wherein triggering of the emergency brake is suppressed in a rail vehicle which is located in a tunnel or on a bridge.

7. The method of claim 3, wherein the open-loop-controlled or closed-loop-controlled system contains a speed control device of the rail vehicle, wherein the speed of the rail vehicle is subjected to closed-loop control as a function of the at least one position-related peripheral condition.

8. The method of claim 3, wherein the open-loop-controlled or closed-loop-controlled system contains an open-loop brake control system or a closed-loop brake control system of the rail vehicle, which control system is adapted as a function of the at least one position-related peripheral condition.

9. The method of claim 4, wherein the open-loop-controlled or closed-loop-controlled system contains a device for detecting derailing of the rail vehicle, wherein a threshold value for the triggering of a detection signal for derailing is adapted as a function of the current position of the rail vehicle.

10. The method of claim 4, wherein the open-loop-controlled or closed-loop-controlled system contains an emergency brake device of the rail vehicle, wherein triggering of the emergency brake is suppressed in a rail vehicle which is located in a tunnel or on a bridge.

11. The method of claim 4, wherein the open-loop-controlled or closed-loop-controlled system contains a speed control device of the rail vehicle, wherein the speed of the rail vehicle is subjected to closed-loop control as a function of the at least one position-related peripheral condition.

12. The method of claim 3, wherein the open-loop-controlled or closed-loop-controlled system contains an open-loop brake control system or a closed-loop brake control system of the rail vehicle, which control system is adapted as a function of the at least one position-related peripheral condition.
